(19) United States
(12) Patent Application Publication
(10) Pub. No.: US 2005/0203929 A1
(43) Pub. Date: Sep. 15, 2005

(54) System, method and computer program product for prioritizing contacts

(76) Inventors: Devapratim Hazarika, San Francisco, CA (US); Frank Kang, San Francisco, CA (US)

Correspondence Address: SQUIRE, SANDERS & DEMPSEY L.L.P, 600 HANSEN WAY, PALO ALTO, CA, 94304-1043, US

(21) Appl. No.: 11/074,963

(22) Filed: Mar. 7, 2005

Related U.S. Application Data
(60) Provisional application No. 60/551,555, filed on Mar. 9, 2004.

(51) Int. Cl. G06F 7/00

(52) U.S. Cl. 707/100

(57) ABSTRACT

A system, method and computer program product for ranking contacts are described. In one embodiment, contacts of a user may be identified. For each contact, a score may be calculated based on messages associated with the contact. The contacts may then be ranked based on the calculated scores.

### CROSS-REFERENCE TO RELATED APPLICATIONS

This application claims the benefit of U.S. Provisional Application No. 60/551,555, filed Mar. 9, 2004 which is incorporated by reference herein in its entirety.

### TECHNICAL FIELD

Embodiments of the present invention relate generally to information management and, more particularly, to organizing contacts.

### BACKGROUND

Electronic Mail (“email” or “e-mail”), essentially an electronic version of the postal service, is an application that is used to communicate electronic information between individuals. Each year, billions of messages are transported between friends, business acquaintances, junk e-mailers, members of mailing lists, etc. Each message typically contains at least one sender and one recipient email address. These addresses define where an email is delivered and who ultimately receives a copy of the message. These messages are traditionally stored in an email database: a database that contains email sent and received by the user and that may often be expanded to include contact records defining individuals that the user communicates with via email.

As email replaces the phone and the postal service as the primary method of communication between people in the business environment, a great deal of data about the relationships between the email user and the user's contacts can be stored within the email database. Some of this data may be manually entered by the user into the traditional email application, such as contact information. There may also be a wealth of information kept in the email database regarding the connection between the user and the user's email contacts, in particular, frequency of communication between the user and each of given contacts.

### SUMMARY

A system, method and computer program product for ranking contacts are described. In one embodiment, contacts of a user may be identified. For each contact, a score may be calculated based on messages associated with the contact. The contacts may then be ranked based on the calculated scores.

In one embodiment, the contacts may be identified from a messaging application. In another embodiment, at least a portion of the contacts may be identified from a contact database. In one implementation, the contact database may comprise a contact list.

In another embodiment, the messages may comprise email messages. In a further embodiment, the messages may be stored in a message database. In an additional embodiment, at least a portion of the contacts may be identified from the messages.

In yet another embodiment the calculated score may be based on the number of messages sent by the user to the contact (“sent messages”) and/or the number of messages received by the user from the contact (“received messages”). In one embodiment, the calculated score may be based on a scaled sum of the number of sent messages and the number of received messages. In a further embodiment, the calculated score may be adjusted based on a ratio of the number of sent messages to the number of received messages if the number of messages sent by the user to the given contact meets a threshold value. In even a further embodiment, the calculated score may be decreased based on a threshold scaling factor if the number of sent messages is less than the threshold value. In yet another embodiment, the calculated score may be adjusted based on the ages of the messages.

In even another embodiment, a statistical analysis may be performed on the calculated scores to rank the contacts. In one implementation, the statistical may comprise a frequency analysis of the calculated scores.

### BRIEF DESCRIPTION OF THE DRAWINGS

FIG. 1 is schematic block diagram of an exemplary system for ranking contacts in accordance with one embodiment;

FIG. 2 is a flowchart of a process for ranking contacts in accordance with one embodiment;

FIG. 3 is a flowchart of an exemplary implementation of a process for identifying contacts of a user;

FIG. 4 is a flowchart of an exemplary implementation of a process for calculating a score for each contact based on messages associated with the contact;

FIG. 5 is a flowchart of an illustrative implementation of a process for ranking contacts in accordance with an exemplary embodiment;

FIG. 6 is a flowchart of an illustrative implementation of a process for calculating a score for a contact in accordance with an exemplary embodiment;

FIG. 7 is a schematic diagram of an illustrative network system in accordance with one embodiment; and

FIG. 8 is a schematic diagram of a representative hardware environment in accordance with one embodiment.

### DETAILED DESCRIPTION

In general, various embodiments may be implemented to analyze email history and contact information (as stored in an electronic database of email messages) to determine from which contacts a user sends and receives the greatest volume of email. For example, embodiments may be implemented to provide a method for extracting and prioritizing contacts stored in an email application's data store (e.g., Microsoft Outlook's .pst file) by analyzing past email history and assessing the priority of the contact. Contacts may then be prioritized (i.e., ranked) according to volume thereby helping to give the user an accurate picture of the user's most important email connections.

In accordance with one embodiment, a contact may be defined as an application specific contact identity record such as, for example, a Microsoft Exchange contact record, an X.400 record, or a Lightweight Directory Access Protocol (LDAP) contact definition. A contact may also be defined as an email address, a group of related email addresses for a single individual/node, and/or even a group of email addresses, identified by a single identifier that can represent a mailing list, or group of related contacts, such as an organization or sub-component of an organization (e.g., a department).

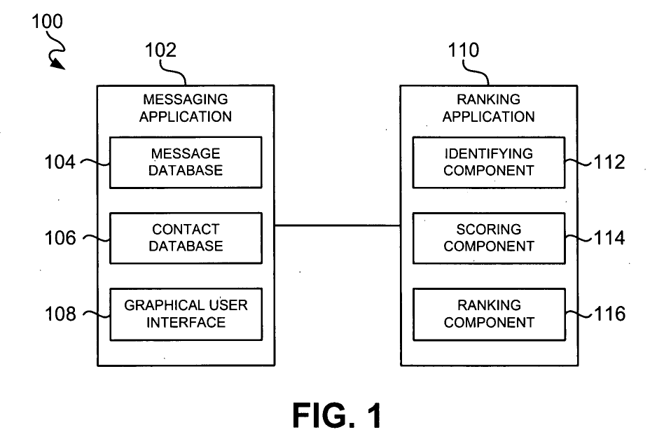

FIG. 1 is schematic block diagram of an exemplary system 100 for ranking contacts in accordance with one embodiment. The system 100 may include a messaging application 102 (e.g., MS Outlook, MS Outlook Express, Hotmail) for sending and receiving messages (e.g., email messages), for example, via a network such as the Internet or an intranet. The messaging application 102 may include a message database 104 in which messages that have been sent from and/or received by the user/ messaging application may be stored and/or retrieved. The messaging application 102 may also include a contact database 106 (e.g., an address book and/or a contact list) in which contact information may be stored and/or retrieved. Depending on the implementation, the message database 104 and/or the contact database 106 may be exclusive to the user or shared by a plurality of users. In a shared implementation, the messages and contacts stored in these databases 104, 106 may include identifiers for identifying the user to which the messages and contacts are associated. The messaging application 102 may further include a graphical user interface 108 for helping facilitate user interaction with the messaging application 102 (including the other elements thereof). It should be understood that an embodiment of the system 100 may be implemented where the message database and/or contact database are external to and/or separate from the messaging application 102. In addition, the message database 104 and/or contact database 106 may be accessible to users, components and/or other applications directly and/or through the messaging application 102.

The system 100 may also have a ranking application 110 coupled to the messaging application 102. The ranking application 110 may include an identifying component 112 capable of identifying contacts in the message and contact databases 104, 106. The ranking application 110 may also have a scoring component 114 capable of calculating scores for contacts identified by the identifying component 112. The ranking application 110 may further include a ranking component 116 capable of ranking the contacts according to the scores calculated by the scoring component 114.

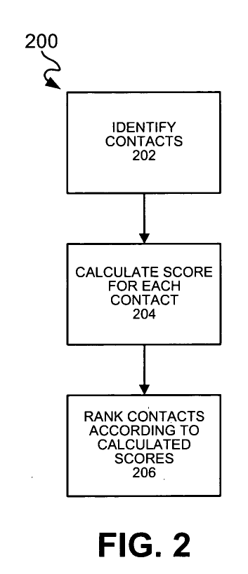

FIG. 2 is a flowchart of a process 200 for ranking contacts in accordance with one embodiment. The system 100 may be utilized to carry out implementations of the process 200 shown in FIG. 2. In operation 202, contacts of a user may be identified. For each contact, a score may be calculated based on messages associated with the contact in operation 204. The contacts may then be ranked based on the calculated scores in operation 206.

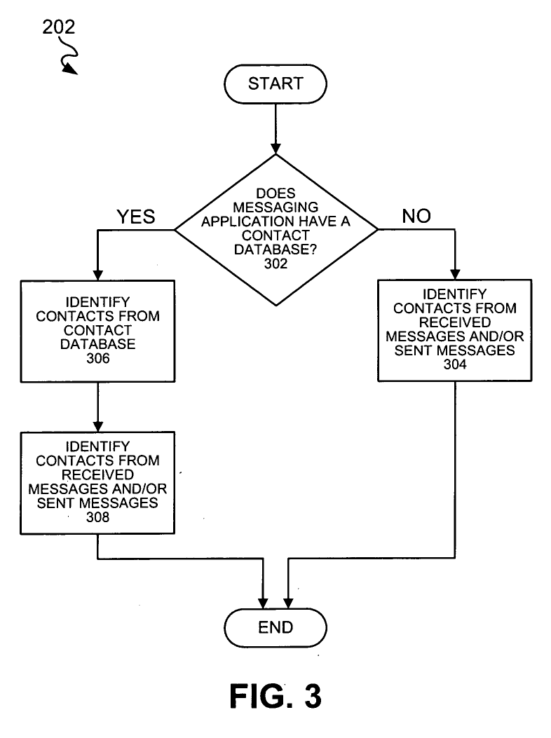

Operation 202 of the process 200 set forth in FIG. 2 may be implemented utilizing the identifying component 112 of the ranking application 110. FIG. 3 is a flowchart of an exemplary implementation of operation 202 for identifying contacts of a user. In operation 302, a determination may be made as to whether the messaging application 102 has a contact database 106. If messaging application 102 is determined not to have a contact database 106 and/or if the contact database 106 is determined not to have any user contacts, then contacts may be identified from messages of the user (e.g., email messages sent from and received by the user) in operation 304. To identify the messages, the identifying component 112 may access the message database 104 directly and/or via the messaging application 102.

On the other hand, if the messaging application 102 is determined to have a contact database 106, then in operation 306 at least a portion of the user's contacts (and preferably all of the user's contacts) may be identified from the contact database 106. In one implementation, the identifying component 112 may access the contact database 106 directly and/or via the messaging application 102. After contacts from the contact database have been identified, then messages of the user in the message database 104 may be analyzed by the identifying component 112 in operation 308 (in a manner similar to that set forth in operation 304) to identify any other contacts present in the messages that were not identified in the contact database 106.

In an email application implementation of operation 306, if the email application (i.e., a messaging application) contains an address book (i.e., a contact database), then all contacts in the address book may be extracted for analysis. In accordance such an exemplary implementation, an address book may comprise any combination of the following: a single collection of contact records as stored in an email application's data store and/or several collections of contact records, including those in multiple data stores that the user has access to (e.g. global Microsoft Exchange address books, address books in archive folders, web based address books, LDAP and other directory services, and/or address books contained within multiple .pst files). In such an exemplary implementation, email within the application may then scanned (in accordance with operations 304 and/or 308) to identify and extract contacts that are part of the email history, but are not entered in the user's email application address book.

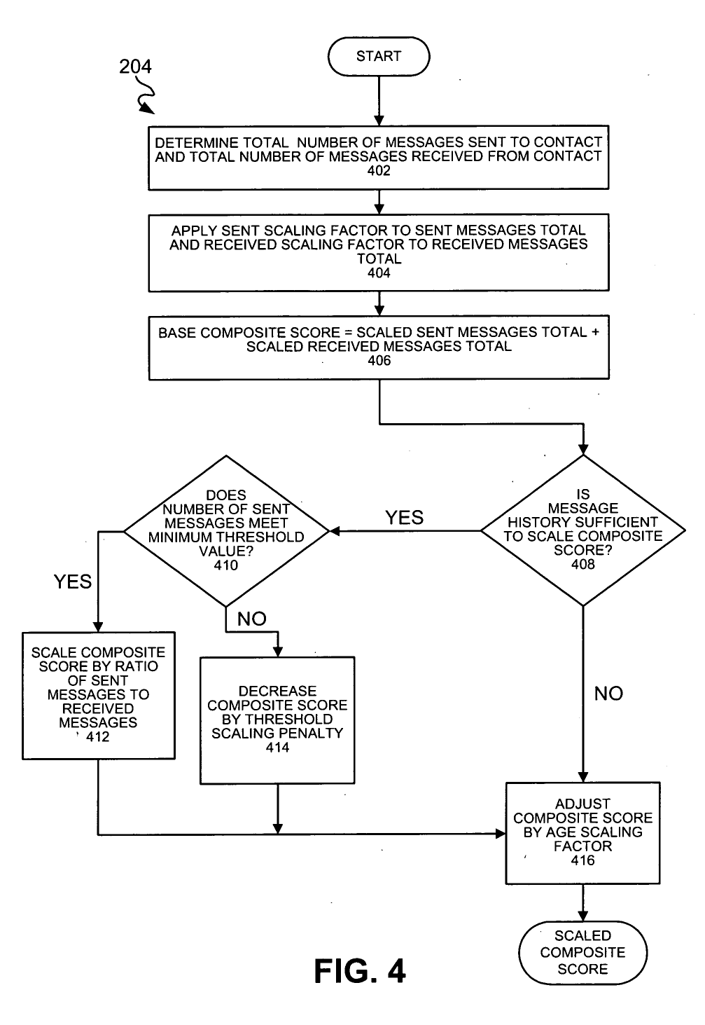

Operation 204 of the process 200 set forth in FIG. 2 may be implemented utilizing the scoring component 114 of the ranking application 110. FIG. 4 is a flowchart of an exemplary implementation of operation 204 for calculating a score for each contact based on messages associated with the contact. In operation 402, the total number of messages sent by the user to the given contact (“sent messages”) and the total number of messages received by the user from the given contact (“received messages”) is determined/calculated from the messages in the message database 104. It should be noted that determination carried out in operation 402 may be performed by the scoring component 114 and/or the identifying component 112 (in which case the identifying component 112 will provide the determined numbers to the scoring component 114).

In operation 404, a sent message scaling factor may be applied (e.g., multiplied or added) to the determined number of sent messages to derive a scaled sent message score and a received message scaling factor may be applied (e.g., multiplied or added) to the determined number of received messages to derive a scaled received message score. In operation 406, the scaled sent message score and the scaled received message score may be added together to obtained a composite score (or “sum”).

If the number of sent messages meets (i.e., greater than or equal to) a minimum threshold value in operation 410, then the composite score may be adjusted (e.g., scaled) either up or down by a ratio of the number of sent messages to the number of received messages in operation 412. If, on the other hand, the number of sent messages determined to be is less than the minimum threshold value, then the composite score may be adjusted (e.g., decreased) by a threshold scaling factor/penalty in operation 414.

In operation 416, the composite score may be adjusted based on the ages of sent and received messages associated with the given contact. In an exemplary implementation of operation 416, an analysis may be made that takes into account the age of received messages and/or sent messages to help ensure that more recent message activity may be given a higher score than earlier (i.e., older) activity. Based on this analysis, the score may then be modified by an age scaling factor to adjust the score to reflect the age of the sent and received messages related to that particular contact. In such an implementation, maximum and minimum values for an aging factor(s) may also be set to help limit or collar the impact that aging can have on a single score. In accordance with one implementation, a score may be reduced by a given percentage per month of age up to a maximum percentage reduction using an age scaling factor. For example, the score of a given message may be reduced by a 10% age penalty (i.e., age scaling factor) for each month of its age up to a given month limit such as, for example, seven months (i.e., a 70% maximum aging penalty).

In one embodiment, operation 410 may be performed after a determination has been made that indicates that the message history includes a sufficient amount/number of messages (see operation 408). For example, such an implementation, operation 410 may be performed if the determination in operation 408 indicates that the total number of messages of the user (i.e., both sent and received messages) meets a threshold total number of messages. In such an embodiment, operation 416 may be performed directly to the basic composite score calculated in operation 406.

The scaled composite score output from the scoring process 202 in FIG. 4 may then be used by the ranking component 116 to rank the given contact with respect to the other identified user contacts in accordance with operation 206 of FIG. 2. In one embodiment, the ranking component 116 may perform a statistical analysis on the calculated scores (i.e., the scaled composite scores of identified contacts) to determine a distribution of the calculated/adjusted scores and rank the contacts according to the statistical analysis/calculated scores. In one implementation, the performed statistical analysis may comprise a frequency analysis of the calculated scores. In accordance with one embodiment, a result of the ranking may be a prioritized list of contacts associated with the user (e.g., contained in the message history and contact data store of a user's email application) with those contacts having a higher volume placed at a higher rank in the list.

In accordance with one implementation, contacts may be ranked in order of the calculated score using a percentile breakdown to group scores (i.e., use predefined percentile values to place entries in priority groups) with contacts having scores in the highest percentile group being identified as very important contacts (or most important contacts) and contacts having scores in the lowest percentile group being identified as irrelevant or least important contacts.

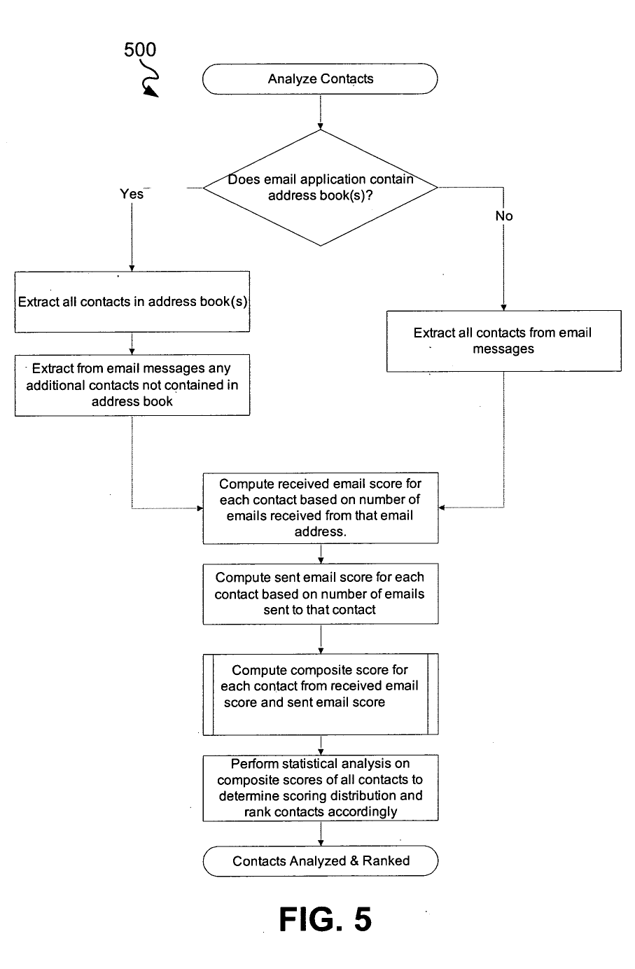

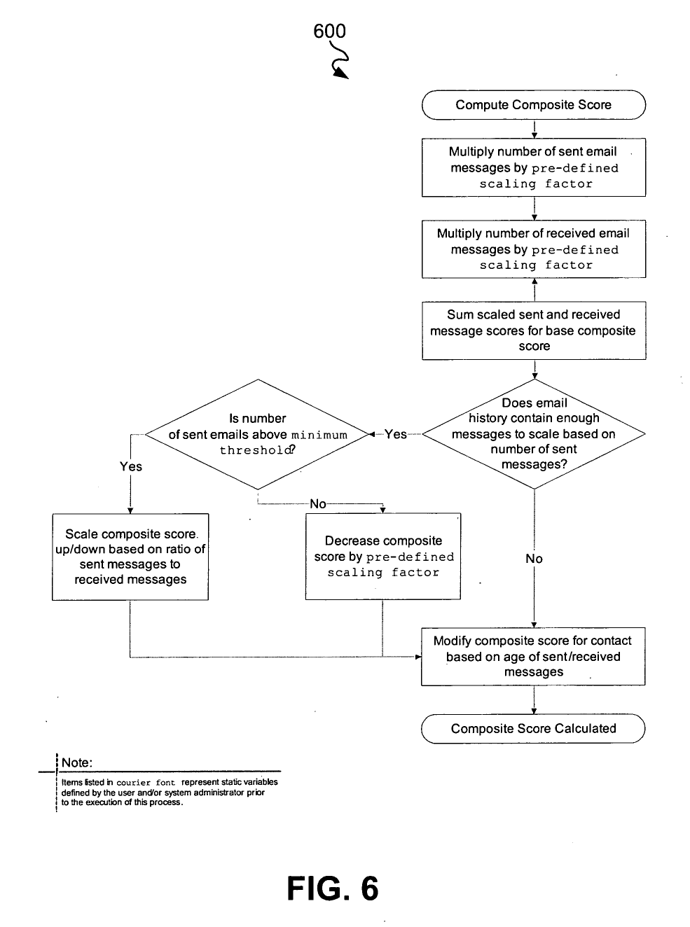

FIG. 5 is a flowchart depicting an exemplary implementation of a process 500 for extracting and analyzing contacts contained within an electronic mail system in accordance with one embodiment. FIG. 6 provides further detail on an exemplary implementation of a process 600 for the calculation of a composite score that may be utilized in assessing the priority of a given contact to the user in accordance with the process 500 set forth in FIG. 5. Please note that in that text presented in courier font in FIG. 6 may represent static variables defined by a user and/or a system administrator prior to the execution of the processes set forth in FIGS. 5 and 6.

Some examples for utilizing various embodiments are as follows. One use of an embodiment of the contact ranking process may be to analyze contacts stored in an email application data store to prioritize email listed in tabular form within an Inbox of the email application to aid a user in overcoming “email overload,” that is, the receipt of too many emails to effectively process in the time available to the recipient. Embodiments may also be utilized to assist a user in sorting through high volumes of email to identify those emails that may be most likely to be important to that particular user. For example, email received from individuals with a higher assigned contact priority may be positioned at the top of the user Inbox. In one such exemplary implementation, a ranking process may be performed against an email application data base (such as a Microsoft Outlook .pst file) to extract all contacts within a user's address book as well as any additional contacts that might be located in email message history and rank those contacts as described above. Incoming email to the user may then be ordered by the sender's (i.e., the contact) assessed rank with email from the most important contacts placed at the top of the inbox and those from the least important contacts at the bottom. As a further option, an email message's appearance may be changed in color (or other change in appearance) to help reflect the sender's rank. For example an important sender's email (i.e., an email message from a highly ranked contact) may be displayed in a red color while a less important sender's email may be displayed in a green, and “junk” sender's email (e.g., a contact that has a very low ranking) in a grey or normal color used by the email application for incoming messages.

Embodiments may also be implemented to help define the strength and/or degree of trust between a given user and the individuals (i.e., contacts) contained in the user's email and contacts for enhancing an electronic social networking scheme, ecommerce transactions, job hunting, sales generation, auctioning, matchmaking and any other electronically brokered interactions where the level of the relationship between the two parties may represent a factor in the transaction. For instance, when searching for a job, a user may be able to identify those individuals with which the user has a high email volume as the contacts most likely to provide recommendations to potential employers.

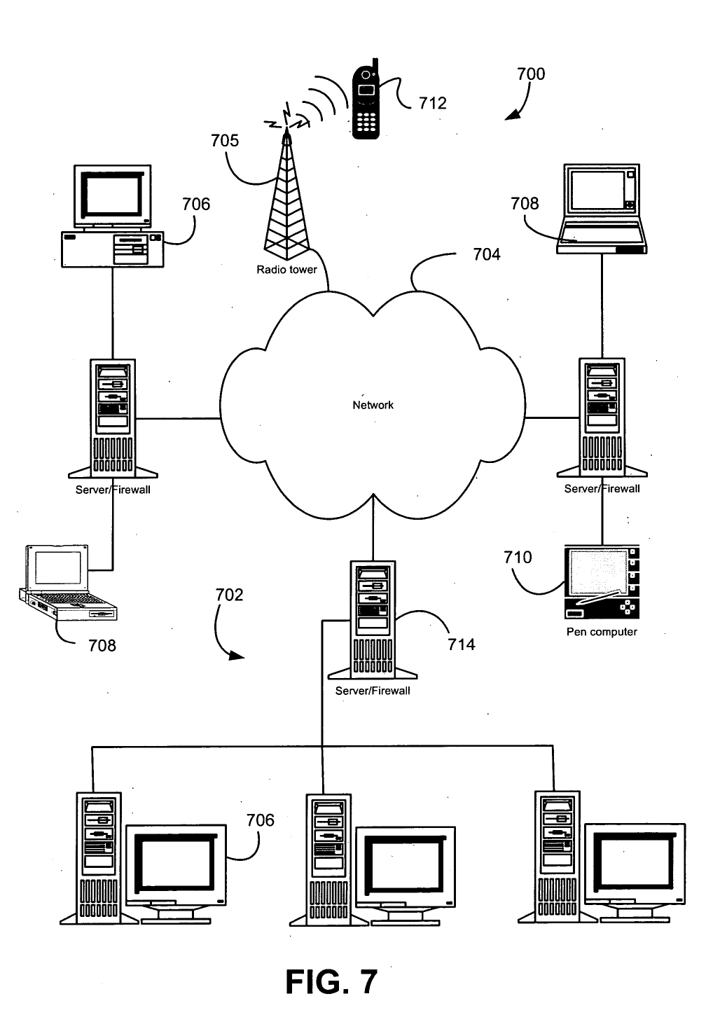

FIG. 7 illustrates an exemplary network system 700 with a plurality of components 702 in accordance with one embodiment of the invention. As shown, such components include a network 704 which take any form including, but not limited to a local area network, a wide area network such as the Internet, and a wireless network 705. Coupled to the network 704 is a plurality of computers which may take the form of desktop computers 706, lap-top computers 708, hand-held computers 710 (including wireless devices 712 such as wireless PDA's or mobile phones), or any other type of computing hardware/software. As an option, the various computers may be connected to the network 704 by way of a server 714 which may be equipped with a firewall for security purposes. It should be noted that any other type of hardware or software may be included in the system and be considered a component thereof.

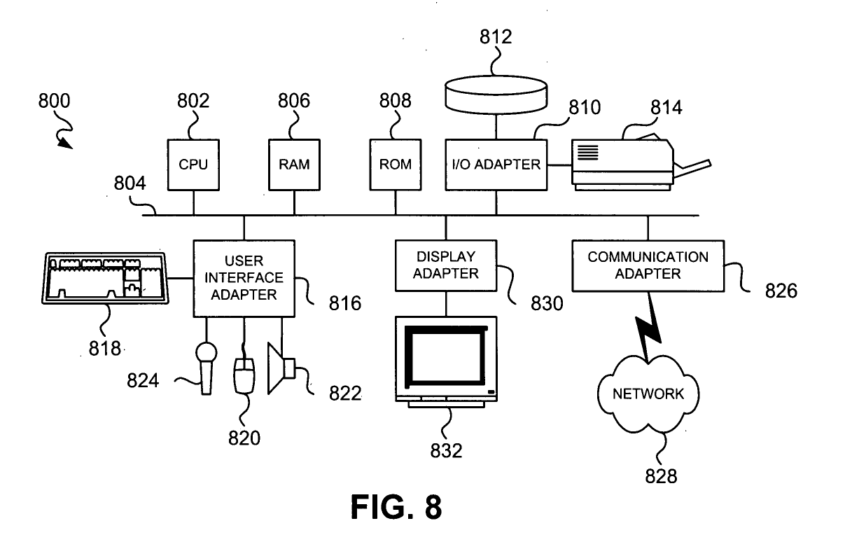

A representative hardware environment associated with the various components of FIG. 7 is depicted in FIG. 8. In the present description, the various sub-components of each of the components may also be considered components of the system. For example, particular software modules executed on any component of the system may also be considered components of the system. In particular, FIG. 8 illustrates an exemplary hardware configuration of a workstation 800 having a central processing unit 802, such as a microprocessor, and a number of other units interconnected via a system bus 804.

The workstation shown in FIG. 8 includes a Random Access Memory (RAM) 806, Read Only Memory (ROM) 808, an I/O adapter 810 for connecting peripheral devices such as, for example, disk storage units 812 and printers 814 to the bus 804, a user interface adapter 816 for connecting various user interface devices such as, for example, a keyboard 818, a mouse 820, a speaker 822, a microphone 824, and/or other user interface devices such as a touch screen or a digital camera to the bus 804, a communication adapter 826 for connecting the workstation 800 to a communication network 828 (e.g., a data processing network) and a display adapter 830 for connecting the bus 804 to a display device 832. The workstation may utilize an operating system such as the Microsoft Windows Operating System (OS), the IBM OS/2 operating system, the MAC OS, or UNIX operating system. Those skilled in the art will appreciate that the various embodiments of the invention may also be implemented on platforms and operating systems other than those mentioned. Embodiments of the invention may also be written using Java, C, and the C++ language and utilize object oriented programming methodology.

In accordance with at least one embodiment, an address book or contact list may comprise a database in which email addresses and/or other contact information (e.g., e.g., name, address, telephone and facsimile numbers, email and website addresses, personal data) about individuals and/or groups may be stored. An address book/contact list may also be integrated with other components of a messaging application to help facilitate quick addressing of messages to be sent to a recipient. An address book/contact list may also permit the assigning of nicknames to a contact or group of contacts to help facilitate quicker access to the contact(s).

Lightweight Directory Access Protocol (LDAP) comprises a set of protocols for accessing information directories. LDAP allows access to a directory service. In particular, LDAP provides access for management and browser applications that provide read/write interactive access to the X.500 Directory (the CCITT and ISO Standard for electronic directory services.) LDAP is based on the standards contained within the X.500 standard and supports TCP/IP. Both X.500 and LDAP define the interactions between directory components to provide a global directory service. A typical LDAP server may comprise a network-accessible database where an organization stores information about its authorized users and what privileges each user has. With LDAP, rather than create a new employee an account on numerous different computers, a new employee may be entered into via LDAP server and granted rights to the other computers. LDAP servers may be implemented using a standard relational database management system (RDBMS) and may communication via XML served over HTTP.

X.400 is a messaging/electronic email standard specified by the ITU-TS (International Telecommunications Union—Telecommunication Standard Sector). X.400 is an standard for email and electronic messaging. X.400 is designed to facilitate international message and information exchange between subscribers of computer based store-and-forward services and office information systems in association with public and private data networks. In X.400, a header precedes the message and may be used to obtain information relating to the transmission, or delivery or request notices.

Wireless refers to a communications, monitoring, or control system in which electromagnetic radiation spectrum or acoustic waves carry a signal through atmospheric space rather than along a wire. In most wireless systems, radio frequency (RF) or infrared transmission (IR) waves are used. Some monitoring devices, such as intrusion alarms, employ acoustic waves at frequencies above the range of human hearing.

A pop-up is a graphical user interface (GUI) display area, usually a small window, that suddenly appears (“pops up”) in the foreground of the visual interface. Pop-ups can be initiated by a single or double mouse click or rollover (sometimes called a mouseover), and also possibly by voice command or can simply be timed to occur. A pop-up window is usually smaller than the background window or interface; otherwise, it is may be called a replacement interface. On the World Wide Web, JavaScript (and less commonly Java applets) may be used to create interactive effects including pop-up and full overlay windows. A menu or taskbar pulldown can be considered a form of pop-up. So can the little message box you get when you move your mouse over taskbars in many PC applications.

Plug-in applications are programs that can easily be installed and used as part of your Web browser. A plug-in application is recognized automatically by the browser and its function is integrated into the main HTML file that is being presented.

A browser is an application program that provides a way to look at and interact with all the information on the World Wide Web. The word “browser” seems to have originated prior to the Web as a generic term for user interfaces that let you browse (navigate through and read) text files online. A Web browser may be considered a client program that uses the Hypertext Transfer Protocol (HTTP) to make requests of Web servers throughout the Internet on behalf of the browser user. While some browsers also support e-mail (indirectly through e-mail Web sites) and the File Transfer Protocol (FTP), a Web browser may not be required for those Internet protocols and more specialized client programs are more popular.

Encryption is the conversion of data into a form, called a ciphertext, that cannot be easily understood by unauthorized people. Decryption is the process of converting encrypted data back into its original form, so it can be understood. Rivest-Shamir-Adleman (RSA) is an Internet encryption and authentication system that uses an algorithm developed in 1977 by Ron Rivest, Adi Shamir, and Leonard Adleman. The RSA algorithm is a commonly used encryption and authentication algorithm and is often included as part of a web browser. The RSA algorithm involves multiplying two large prime numbers (a prime number is a number divisible only by that number and 1) and through additional operations deriving a set of two numbers that constitutes the public key and another set that is the private key. Once the keys have been developed, the original prime numbers are no longer important and can be discarded. Both the public and the private keys are needed for encryption/decryption but only the owner of a private key ever needs to know it. Using the RSA system, the private key never needs to be sent across the Internet. The private key is used to decrypt text that has been encrypted with the public key. Thus, if a first party sends a message to a second party, the recipient second party may be able to find out the first party's public key (but not the first party's private key) from a central administrator and encrypt a reply message back to the first party using the first party's own public key. When the first party receives the reply message, the reply message may be decrypted by the first party with the first party's private key. In addition to encrypting messages (which ensures privacy), a first party may be able authenticate themselves to second party so that the second party can confirm the identity of the first party (and thus know that it is really the first party who sent the message) by using a private key to encrypt a digital certificate. When the second party receives the encrypted digital certificate, the second party may use the first party's public key to decrypt it.

Based on the foregoing specification, embodiments of the invention may be implemented using computer programming or engineering techniques including computer software, firmware, hardware or any combination or subset thereof. Any such resulting program—having computer-readable code—may be embodied or provided in one or more computer-readable media, thereby making a computer program product (i.e., an article of manufacture) implementation of one or more embodiments described herein. The computer readable media may be, for instance, a fixed drive (e.g., a hard drive), diskette, optical disk, magnetic tape, semiconductor memory such as for example, read-only memory (ROM), flash-type memory, etc., and/or any transmitting/receiving medium such as the Internet and/or other communication network or link. An article of manufacture containing the computer code may be made and/or used by executing the code directly from one medium, by copying the code from one medium to another medium, and/or by transmitting the code over a network. In addition, one of ordinary skill in the art of computer science may be able to combine the software created as described with appropriate general purpose or special purpose computer hardware to create a computer system or computer sub-system embodying embodiments or portions thereof described herein.

While various embodiments have been described above, it should be understood that they have been presented by way of example only, and not limitation. Thus, the breadth and scope of a preferred embodiment should not be limited by any of the above described exemplary embodiments, but should be defined only in accordance with the following claims and their equivalents.

1. A method for ranking contacts, comprising:
identifying contacts of a user;
for each contact, calculating a score based on messages associated with the contact; and
ranking the contacts based on the calculated scores.

2. The method of claim 1, wherein the contacts are identified from a messaging application.

3. The method of claim 1, wherein at least a portion of the contacts are identified from a contact database.

4. The method of claim 1, wherein the contact database comprises a contact list.

5. The method of claim 1, wherein the messages comprise email messages.

6. The method of claim 1, wherein at least a portion of the contacts are identified from the messages.

7. The method of claim 1, wherein the messages are stored in a message database.

8. The method of claim 1, wherein the calculated score is based on at least one of a number of messages sent by the user to the contact and a number of messages received by the user from the contact.

9. The method of claim 1, wherein the calculated score is based on a scaled sum of a number of messages sent by the user to the contact and a number of messages received by the user from the contact.

10. The method of claim 1, wherein the calculated score is adjusted based on a ratio of a number of messages sent by the user to the contact to a number of messages received by the user from the contact if the number of messages sent by the user to the contact meets a threshold value.

11. The method of claim 1, wherein the calculated score is decreased based on a threshold scaling factor if a number of messages sent by the user to the contact is less than a threshold value.

12. The method of claim 1, wherein the calculated score is adjusted based on the ages of the messages.

13. The method of claim 1, wherein a statistical analysis is performed on the calculated scores to rank the contacts.

14. The method of claim 13, wherein the statistical analysis comprises a frequency analysis of the calculated scores.

15. A system for ranking contacts, comprising:
logic for identified contacts of a user;
logic for calculating a score for each contact based on messages associated with the contact; and
logic for ranking the contacts based on the calculated scores.

16. The system of claim 15, wherein the contacts are identified from a messaging application.

17. The system of claim 15, wherein the calculated score is based on at least one of a number of messages sent by the user to the contact and a number of messages received by the user from the contact.

18. The system of claim 15, wherein the calculated score is adjusted based on a ratio of a number of messages sent by the user to the contact to a number of messages received by the user from the given contact if the number of messages sent by the user to the given contact meets a threshold value.

19. The system of claim 1, wherein the calculated score is adjusted based on the ages of the messages.

20. A computer program product for ranking contacts, comprising:
computer code for identified contacts of a user;
computer code calculating a score for each contact based on messages associated with the contact; and
computer code for ranking the contacts based on the calculated scores.
